(19) United States
(12) Patent Application Publication
(10) Pub. No.: US 2014/0303767 A1
(43) Pub. Date: Oct. 9, 2014

(54) Method for Operating a Production Plant

(71) Applicants: Willi Klumpp, Ostfildern (DE); Matthias Reichenbach, Stuttgart (DE); Matthias Schreiber, Bietigheim-Bissingen (DE); Volker Zipter, Stuttgart (DE); Michael Zuern, Sindelfingen (DE)

(72) Inventors: Willi Klumpp, Ostfildern (DE); Matthias Reichenbach, Stuttgart (DE); Matthias Schreiber, Bietigheim-Bissingen (DE); Volker Zipter, Stuttgart (DE); Michael Zuern, Sindelfingen (DE)

(73) Assignee: Daimler AG, Stuttgart (DE)

(21) Appl. No.: 14/362,814

(22) PCT Filed: Dec. 9, 2011
(86) PCT No.: PCT/EP2011/006202

§ 371 Date: Jun. 4, 2014

(51) Int. Cl. G05B 19/418

(52) U.S. Cl. CPC G05B 19/418
USPC 700/105

(57) ABSTRACT

A method for operating a production plant having a plurality of work stations to carry out at least one respective work step by a control system allocated to the production plant involves a control system assigning human workers or robots to work stations according to at least one criterion relating to a production requirement, wherein each worker or robot can be assigned to one or several work stations.

### BACKGROUND AND SUMMARY OF THE INVENTION

Exemplary embodiments of the present invention relate to a method to operate a production plant.

Production plants in which both people and robots are used are usually constructed such that specific work stations of the production plant are operated by human workers and other work stations of the production plant are operated by robots. The design of the production plant is fixed in this respect; the distribution of work stations to people or robots is fixedly prescribed. Therefore, the robots are usually also fixedly mounted on their respective work stations, such that a flexible reconfiguration of the production plant is not possible and the malfunction of individual units leads to a standstill of the entire plant. Together with the often likewise fixed installation of transport systems, this also leads to a fixed cycle time of the plant, such that the throughput of the plant is not flexibly adjustable to current production requirements.

European patent document EP 1 570 324 B1 discloses a method for dynamic automation in which mobile robots are used, which negotiate different work spaces depending on work steps to be carried out and there co-operate with human workers in that they communicate orders to the human workers with regard to the work steps to be carried out. Such systems have an increased flexibility; the self-moving nature of the robots, however, puts high requirements on their programming, such that even here, changes are difficult to carry out.

Exemplary embodiments of the present invention are directed to a method to operate a production plant that enables a particularly flexible and simple adaptation of the operation of the production plant to different production requirements.

Such a method relates to the operation of a production plant having a plurality of work stations to carry out at least one respective work step. A control system allocated to the production plant is provided to operate the production plant. By means of the control system, human workers or robots are assigned according to the invention according to at least one criterion relating to a production requirement, wherein each worker or robot can be assigned to one or more work stations. In other words, by means of the control system, the respective required number of human workers and robots can be assigned flexibly and according to need to the individual work stations of the production plant in order to operate the production plant optimally to full capacity at each point in time. Due to this flexible assignment, malfunctioning robots or similar can additionally be replaced without problem or their malfunction can, if necessary, be bridged over in the short-term by the use of human workers. Such a method therefore additionally enables an operation of the production plant with a particularly low level of disruption. Due to the variable number of robots and human workers used, an adaptation of the cycle rate of the production plant to possible outside needs is also possible without problem.

It is therefore particularly expedient to use a number of pieces of a product to be manufactured as the criterion relating to the production requirement. Therefore, an occupancy of the production plant that is suited to the load can be ensured at all times.

In a preferred embodiment, the work stations are exclusively occupied with human workers, if the number of pieces to be manufactured is below a first threshold value. Therefore, in the case of small batch production, start-up batch production or in another situation which requires a low number of production pieces, only human workers are used, as the use of robots, which would not be used to full capacity in the case of these numbers of pieces, is uneconomical here. In the case of particularly low numbers of pieces, a single worker can additionally operate several work stations, such that each worker is used optimally to full capacity and is not under-challenged.

If the number of pieces to be manufactured is above the threshold value for the exclusive human occupancy of the production plant, yet below a second threshold value, then both human workers and robots are assigned to the work stations. This can occur very quickly using the control device, such that in the case of a short-term increase of the production capacity, the human workers are supported by robots.

Above the second threshold value, so in the case of a high number of pieces to be manufactured, for example in complete batch operation, all work stations are exclusively occupied by robots, in order to use the advantages of the automation to full capacity and not to over-challenge the human workers.

Therefore, on the whole, human workers and robots are distributed between the work stations in all operation states of the production plant, such that both the workers and the robots are always used optimally to full capacity and no capacities or resources are wasted.

Therein in it is particularly expedient to use robots in the embodiment of the method, which are designed to recognize imminent collisions with objects in their surroundings and to interrupt a motion sequence in the case of such a recognition. This enables a safe co-operation of people and robots in the direct vicinity, for example within a single work station.

Alternatively or additionally to this, an allocated laser scanner can be arranged at each robot, which scans a conical region that surrounds the robot and interrupts a motion sequence of the robot in the case of the introduction of an object or worker into this region. A conflict between robots and human workers can be reliably avoided both by an active collision recognition by the robots and by allocated laser scanners, without safety fences or similar being necessary. Hereby, the space requirement for the robots in the production plant is reduced, wherein at the same time the flexibility of their arrangement is increased. Particular location changes of the robots can be achieved without problem, as no elaborate safety device must be constructed and de-constructed again.

Preferably, a work task is assigned to each robot respectively and a plurality of work tasks is assigned to each human worker respectively in the case of the simultaneous use of robots and human workers. Each human worker can therefore operate, for example, a plurality of robots and supply them with primary products. Such an arrangement uses the particular flexibility of human workers, while the robots, for example, are used for repetitive tasks which are carried out particularly quickly.

For optimal use of the work stations to full capacity, it is furthermore expedient to use respective tools in the work stations that are operable both by human workers and by robots. In a case of a change of occupancy, the work stations thus do not have to be re-adapted to the human workers or the robots, but can continue to be used without a pause. For this purpose, the robots can, for example, be designed to use tools designed for human hands. For this purpose, the manipulators of the robots would then be adapted accordingly. Alternatively, it is possible to use accordingly adapted tools, which, for example, have two handling regions. A first handling region would be ergonomically adapted to the human hand, while a second handling region is designed to interact with the manipulator of a robot.

It is advantageous if at least one work station operated by at least one human worker and/or at least one robot is supplied with primary products and/or material by further human workers. This is above all useful if a work flow is scheduled where certain parts or primary products must be held in stacks and this cannot occur economically in an automated manner.

### BRIEF DESCRIPTION OF THE DRAWING FIGURES

The invention and its embodiments are described in more detail below by means of the drawing. Here are shown:

FIG. 1 a production plant to carry out an exemplary embodiment of the method according to the invention in the case of a small load.

FIG. 2 the production plant according to FIG. 1 in the case of a medium load and

FIG. 3 a robot for use with an exemplary embodiment of the method according to the invention having an allocated laser scanner to protect active workers in its vicinity.

### DETAILED DESCRIPTION

A production plant, identified as a whole by 10, which here is designed to manufacture motor vehicle gears, comprises a plurality of work stations 12, which in turn comprise work surfaces 14 and storage containers 16, which are not all identified here for the sake of clarity. Additionally, machine tools, for example presses 18, are allocated to the work stations 12.

In order to be able to operate the production plant 10 optimally in the case of varying loads, a control device is provided that is not depicted in the figures. This receives information about the number of pieces to be produced or number variants of the manufactured products to be produced and subsequently generates instructions for the occupancy of the work stations 12 from this information.

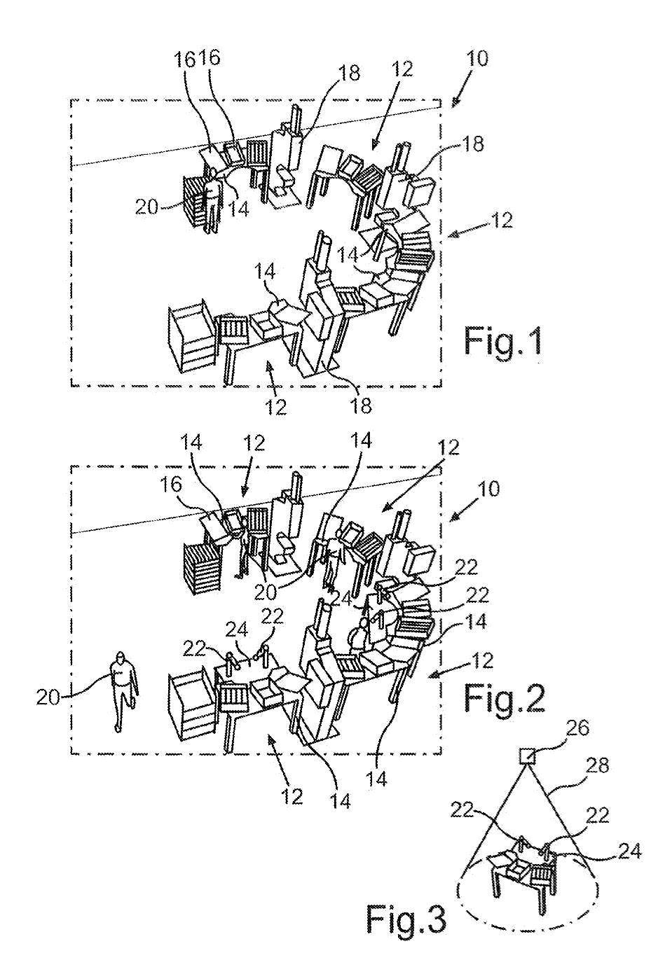

In the situation depicted in FIG. 1, the production plant 10 only has a small load. This situation can, for example, occur in the case of the production of small batches or start-up batch production. The production plant 10 is therefore only operated by one individual human worker 20, who operates all work stations 12 and there carries out the respective scheduled work steps. The worker 20 therefore traverses the work stations 12 arranged in a semi-circle in a predetermined order and therefore produces each product completely himself.

If the requirement for goods to be produced increases, then further human workers 20 can be transferred to take over individual work stations 12 of the production plant 10. Each worker now operates one or two work stations; respectively produced partial products are transferred between the work stations 12.

In the case of a further increasing production requirement, robots 22, as depicted in FIG. 2, can additionally be allocated to the production plant 10. These are arranged on mobile tables 24, which are moved by workers to the respective work station 12 to be operated by a robot 22. Intermediate products of the manufacture in the production plant 10 are now passed between work stations 12 occupied by people and robots, whereby a higher throughput is enabled. The human workers 20 preferably fulfil flexible tasks, while the robots 22 are programmed to a predetermined volume of work of an assembly station 12. The programming can occur by the human workers 20, for example in the form of the so-called teachings. An allocation of wirelessly active programming means, such as for example RFID chips, to the work stations 12 is also possible. These programming means transfer the work program allocated to the respective work station 12 to the robots 22, such that these must only be brought to their standing point and the necessary tasks can be taken over directly.

In the case of further increasing production requirement, individual human workers 20 can be replaced by further robots 22, until finally in the case of the largest load of the production plant 10, all work stations 12 are occupied by robots 22 in order to achieve a particularly high throughput.

On the whole, the production plant 10 can thus be adapted to all necessary load levels, wherein a change of the configuration of the production plant 10 can occur by means of commands of the control device in real time, in order to adapt the production plant 10 quickly to the fluctuating production requirement.

In order to enable the co-operation between human workers 20 and robots 22 in the tight space of the production plant 10, the robots must have particular safety provisions. For example, the robots 22, as shown in FIG. 3, can be provided with allocated laser scanners 26, which scan a conical region 28 around the robots. This region is a security exclusion zone. If the laser scanner 26 determines a breach of the region 28—so the exclusion zone—by introduction of a human worker 20, then the movements of the robots 22 within the region 29 are interrupted in order not to endanger the human worker 20. As well as such external laser scanners, the robots 22 can also be provided with individual collision detection systems, which recognize imminent collisions with objects or workers and interrupt a motion sequence of the robot 22 in this case, until its resumption is safe for all parties concerned.

In order to enable a variation between the use of human workers 20 and robots 22 at the same work stations 12, tools are also used in the work stations 12, preferably exclusively, which are able to be used by both human workers 20 and robots 22. For this purpose, the tools can be adapted such that they have, for example, two different handling regions for human grip and robotic grip. Alternatively, the robots 22 can be adapted such that they can use tools that are designed based on human handling ergonomics. It is herein particularly expedient if the robots 22 have force sensors or toque sensors with which they can determine which force they should exercise on the work piece by means of such tools in order to thus avoid damaging the tools.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for operating a production plant having a plurality of work stations to carry out at least one respective work step, the method comprising:
determining, by a control system, at least one criterion related to a production requirement; and
assigning, by the control system, human workers or robots to the plurality of work stations according to the determined at least one criterion related to a production requirement, wherein each worker or robot can be assigned to one or several work stations.

12. The method of claim 11, wherein the determined at least one criterion relating to the production requirement is a number of pieces of a product to be manufactured.

13. The method of claim 12, wherein the human workers are exclusively assigned to the work stations when the number of pieces to be manufactured is below a first threshold value.

14. The method of claim 13, wherein both human workers and robots are assigned to the work stations when the number of pieces to be manufactured is above the first threshold value and below a second threshold value.

15. The method of claim 14, wherein robots are exclusively assigned to the work stations if the number of work pieces to be manufactured is above the second threshold value.

16. The method of claim 11, wherein the robots are configured to recognize imminent collisions with objects in their environment and to interrupt a motion sequence in the case of such a recognition.

17. The method of claim 11, wherein an allocated laser scanner is arranged on each of the robots, which scans a conical region that surrounds each of the robots and interrupts a motion sequence of a particular one of the robots when a worker is introduced into the conical region.

18. The method of claim 11, wherein when both robots and human workers are assigned, a work task is assigned to each of the robots and a plurality of work tasks is assigned to each of the human workers.

19. The method of claim 11, wherein each of the work stations includes tools operable by both the human workers and by the robots.

20. The method of claim 11, wherein at least one work station that is operated by at least one of the human workers or at least one of the robots is supplied with primary products or materials by further human workers.
